(19) United States
(12) Patent Application Publication
(10) Pub. No.: US 2004/0093219 A1
(43) Pub. Date: May 13, 2004

(54) Home robot using home server, and home network system having the same

(76) Inventors: Ho-Chul Shin, Suwon-city (KR); Kyong-Joon Chun, Seoul (KR); Young-Jip Kim, Suwon-city (KR); Bo-Seung Hwang, Suwon-city (KR); Jae-Kil Lee, Seoul (KR); Ki-Yeon Sung, Suwon-city (KR)

Correspondence Address: Robert E. Bushnell, Suite 300, 1522 K Street, N.W., Washington, DC, 20005, US

(21) Appl. No.: 10/674,509

(22) Filed: Oct. 1, 2003

(30) Foreign Application Priority Data
Nov. 13, 2002 (KR) 70444/2002

(51) Int. Cl. G10L 21/00

(52) U.S. Cl. 704/275

(57) ABSTRACT

A home robot controlled by a home server. When a user gives a voice command to the home robot, the home robot A/D converts the voice command and transmits the voice command to the home server. The home server interprets the voice command, generates a response control signal to the command, and by wireless transmission, transmits the response control signal to the home robot. A control unit in the home robot receives the response control signal, outputs the response control signal as one or more of a digital voice signal, motion control signal and an image signal. The digital voice signal is converted to an analog signal for reproduction through a speaker. A driving unit moves body components of the home robot in response to one or more of the motion control signals from the control unit. A display unit displays an image in response to the image signal.

### CLAIM OF PRIORITY

This application makes reference to, incorporates the same herein, and claims all benefits accruing under 35 U.S.C. §119 from an application for HOME ROBOT USING HOME SER VER, AND HOME NETWORK SYSTEM HAVING THE SAME earlier filed in the Korean Intellectual Property Office on Nov. 13, 2002 and there duly assigned Serial No. 2002-70444.

### BACKGROUND OF THE INVENTION

1. Field of the Invention

The present invention relates to a home network system, and more particularly to, a home robot using a home server and a home network system having the same which can minimize processing operations of the robot, perform the other processing operations in the home server through a network, and enable the robot to perform a command of a user by using the processing results.

2. Description of the Related Art

A robot is a machine designed to execute one or more tasks repeatedly, with speed and precision. There are as many different types of robots as there are tasks for them to perform.

A robot can be controlled by a human operator, sometimes from a great distance. But most robots are controlled by computer, and fall into either of two categories: autonomous robots and insect robots. An autonomous robot acts as a stand-alone system, complete with its own computer. Insect robots work in fleets ranging in number from a few to thousands, with all fleet members under the supervision of a single controller. The term insect arises from the similarity of the system to a colony of insects, where the individuals are simple but the fleet as a whole can be sophisticated.

Robots are sometimes grouped according to the time frame in which they were first widely used. First-generation robots date from the 1970s and consist of stationary, nonprogrammable, electromechanical devices without sensors. Second-generation robots were developed in the 1980s and can contain sensors and programmable controllers. Third-generation robots were developed between approximately 1990 and the present. These machines can be stationary or mobile, autonomous or insect type, with sophisticated programming, speech recognition and/or synthesis, and other advanced features. Fourth-generation robots are in the research-and-development phase, and include features such as artificial intelligence, self-replication, self assembly, and nanoscale size (physical dimensions on the order of nanometers, or units of 10⁻⁹ meter).

A cobot or “collaborative robot” is a robot designed to assist human beings as a guide or assistor in a specific task. A regular robot is designed to be programmed to work more or less autonomously. In one approach to cobot design, the cobot allows a human to perform certain operations successfully if they fit within the scope of the task and to steer the human on a correct path when the human begins to stray from or exceed the scope of the task.

Some advanced robots are called androids because of their superficial resemblance to human beings. Androids are mobile, usually moving around on wheels or a track drive (robots legs are unstable and difficult to engineer). The android is not necessarily the end point of robot evolution. Some of the most esoteric and powerful robots do not look or behave anything like humans. The ultimate in robotic intelligence and sophistication might take on forms yet to be imagined.

A robot which incorporates a body, two arms, two legs, several sensors, an audio system, a light assembly, and a video device is the subject of U.S. Pat. No. 6,507,773 to Parker; Andrew J. Parker et al. and entitled “Multi-functional Robot with Remote and Video System.” Sensors located throughout the body of the robot combined with an edge detection sensor allows the robot to interact with objects in the room, and prevents the robot from traveling off an edge or bumping into obstacles. An audio system allows the robot to detect and transmit sounds. A video device allows a user to remotely view the area in front of the robot. Additionally, the robot may operate in a plurality of modes which allow the robot to operate autonomously. The robot may operate autonomously in an automatic mode, a security mode, a greet mode, and a monitor mode. Further, the robot can be manipulated using a remote control.

U.S. Pat. No. 6,560,511 to Naohiro Yokoo, et al. and entitled “Electronic Pet System, Network System, Robot, and Storage Medium” discusses connection of a robot to the Internet via modems or by Bluetooth modules, which are radio means. In such a case, the robot and a virtual electronic pet device or a personal computer have Bluetooth modules, respectively, as radio transmission/reception sections. Accordingly, the modems or Bluetooth modules are connected to the Internet (e.g., public telephone network) and data transmission/reception is carried out with the Bluetooth module in the robot and the Bluetooth module of the virtual electronic pet device or personal computer. In this case, the Bluetooth is a radio interface using ISM (industrial Scientific Medical) band of 2.4 GHz which does not require permission as the carrier frequency.

U.S. Pat. No. 6,577,924 to Tomoaki Kasuga, et al. entitled “Robot Managing System, Robot Managing Method, and Information Managing Device”discusses connection of a robot to the Internet via a server and personal computer. The personal computer has both a function to send information on a robot to a telecommunication line and a function to receive answer information sent from a server to the robot user via the telecommunication line, and the server generates answer information on the basis of robot-related information sent from the personal computer via the telecommunication line and reference information previously stored in an information storage device and corresponding to the robot-related information and sends the answer information to the personal computer via the telecommunication line. The answer information is a diagnostic report on the robot.

U.S. Pat. No. 6,584,376 to Robert Van Kommer entitled “Mobile Robot and Method for Controlling a Mobile Robot” describes a mobile robot including an autonomous displacement device, a microphone, a loudspeaker, a mobile telephone module, and a voice analysis module able to interpret voice commands through the mobile telephone module to control the displacements of the mobile robot.

FIG. 1 is a structure view illustrating a personal robot disclosed in Korean Laid-Open Patent 2001-016048 by Jin Yeong Jung et al., published Mar. 5, 2001, and entitled “Multipurpose Home Personal Robot” relating to a multi-function home personal robot in which the function of the robot is incorporated into a remote computer.

As illustrated in FIG. 1, a home personal robot 200 processes an image sensed by an image sensor 201 in an image processing unit 207, processes voice sensed by a voice sensor 202 in a voice processing unit 208, and remotely transmits them through a wireless communication module 212. The home personal robot 200 includes a speaker 203 for reproducing voice, a display unit 204 for reproducing the image, a motion processing unit 210 for processing motions, a motor array 206 and an obstacle detecting module 205. In addition, the home personal robot 200 includes a main control unit 209 for controlling each module and a storage unit 211 for storing data.

The home personal robot 200 performs commands of the user, sensing data and other robot operations in the main control unit 209 and auxiliary processors of each module, namely the image processing unit 207, the motion processing unit 210 and the voice processing unit 208. On the other hand, a communication function is used to input/output the commands of the user or remotely upgrade a software required for the robot.

As described above, the robot is designed to process low level processing operations as well as high level processing operations in its microprocessors (main processor and auxiliary processors).

Accordingly, the robot requires a plurality of processors, which increases a unit cost. The robot also rapidly consumes battery power due to its increased weight. Because an operation speed of the robot is dependent upon performance of the processor of the main control unit 209, the robot cannot smoothly perform a high level processing command requiring large capacity calculations.

### SUMMARY OF THE INVENTION

It is, therefore, an object of the present invention to provide a home robot using a home server and a home network system having the same which can minimize a processing load and a unit cost of the robot.

To achieve the above object, there is provided a system for controlling a home robot, comprising: a home server responsive to a user's command for controlling said home robot, said home server and said home robot being in a same premises; and said home robot being controlled to perform only in response to command result signals generated by said home server, said command result signals being generated in response to said user's command.

According to another aspect of the invention, a method for operating a home robot using a home server includes: receiving a voice service request A/D at the home robot, for converting the voice, and transmitting the voice to the home server through wireless communication; receiving the voice at the home server from the home robot, for recognizing the voice, interpreting a requested service by voice recognition, performing operations for the requested service, generating a response message to the requested service, synthesizing the response message into voice, and transmitting the voice response message to the home robot; and receiving the voice response message at the home robot from the home server, for reproducing the voice response message as voice through a speaker.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram illustrating a related multi-function home personal robot;

FIG. 2 is a block diagram illustrating a home network in accordance with a preferred embodiment of the present invention;

FIG. 3 is a block diagram illustrating a home server of FIG. 2; and

FIG. 4 is a block diagram illustrating a home robot of FIG. 2.

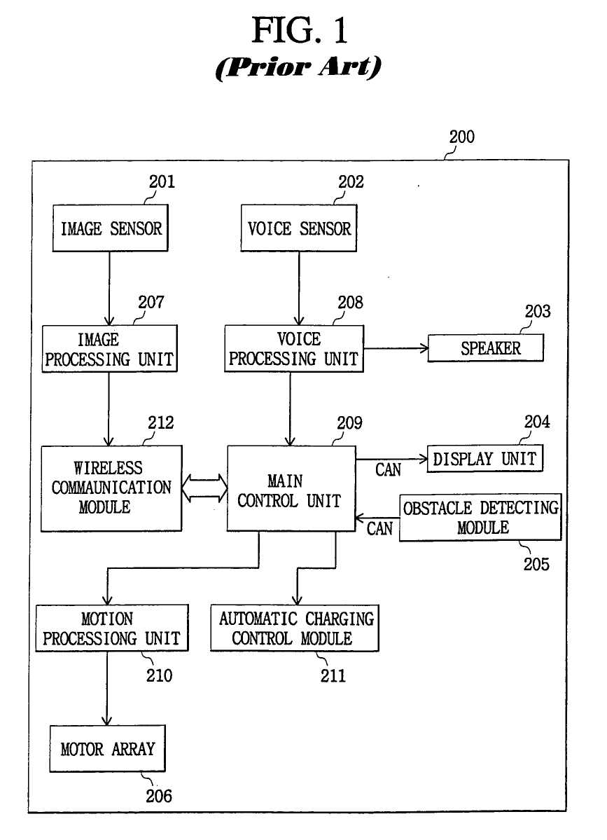

### DETAILED DESCRIPTION OF THE PREFERRED EMBODIMENT

A preferred embodiment of the present invention will now be described with reference to the accompanying drawings. In the following description, same drawing reference numerals are is used for the same elements even in different drawings. The matters defined in the description such as a detailed construction and elements of a circuit are provided to assist in a comprehensive understanding of the invention. However, the present invention can be carried out without those defined matters. Also, well-known functions or constructions are not described in detail since they would obscure the invention in unnecessary detail.

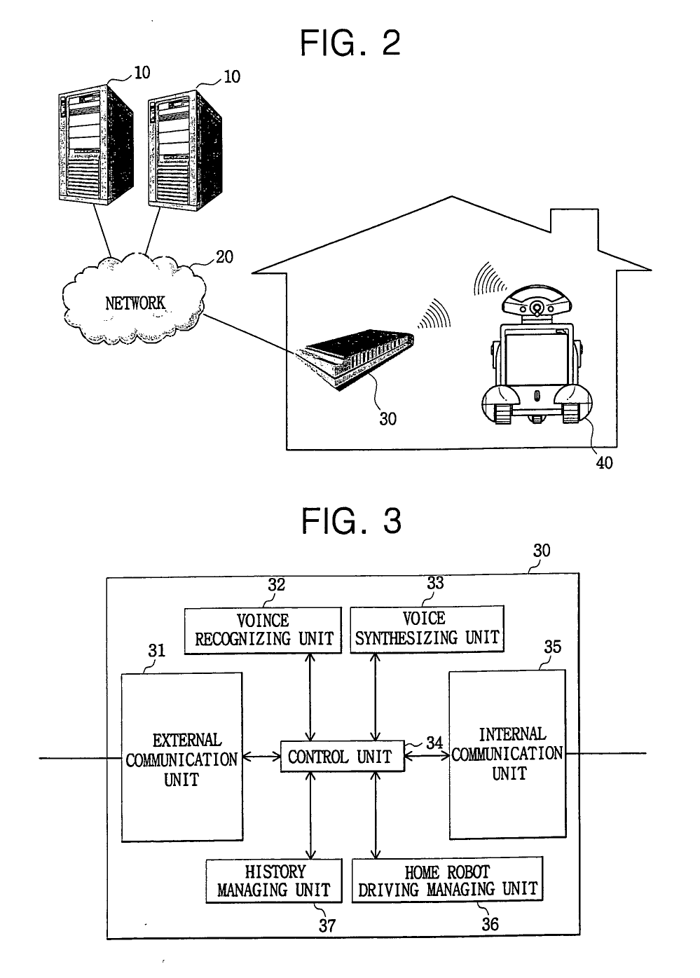

FIG. 2 is a block diagram illustrating a home network in accordance with the preferred embodiment of the present invention. The network includes service servers 10, a physical network 20, a home server 30 and a home robot 40.

In general, a network is a series of points or nodes interconnected by communication paths. Networks can interconnect with other networks and contain subnetworks. The most common topology or general configurations of networks include the bus, star, and token ring topologies. Networks can also be characterized in terms of spatial distance as local area networks (LAN), metropolitan area networks (MAN), and wide area networks (WAN). A given network can also be characterized by the type of data transmission technology in use on it (for example, a TCP/IP or Systems Network Architecture network); by whether it carries voice, data, or both kinds of signals; by who can use the network (public or private); by the usual nature of its connections (dial-up or switched, dedicated or nonswitched, or virtual connections); and by the types of physical links (for example, optical fiber, coaxial cable, and Unshielded Twisted Pair). Large telephone networks and networks using their infrastructure (such as the Internet) have sharing and exchange arrangements with other companies so that larger networks are created. A gateway is a network point that acts as an entrance to another network. On the Internet, a node or stopping point can be either a gateway node or a host (end-point) node. Both the computers of Internet users and the computers that serve pages to users are host nodes. The computers that control traffic within a company's network or at a local Internet service provider (ISP) are gateway nodes. In the network for an enterprise, a computer server acting as a gateway node is often also acting as a proxy server and a firewall server. On the Internet, a node or stopping point can be either a gateway node or a host (end-point) node. Both the computers of Internet users and the computers that serve pages to users are host nodes. The computers that control traffic within a company's network or at a local Internet service provider (ISP) are gateway nodes. In general, a server is a computer program that provides services to other computer programs in the same or other computers. The computer that a server program runs in is also frequently referred to as a server (though it may contain a number of server and client programs). In the client/server programming model, a server is a program that awaits and fulfills requests from client programs in the same or other computers. A given application in a computer may function as a client with requests for services from other programs and also as a server of requests from other programs. Although the client/server idea can be used by programs within a single computer, it is a more important idea in a network. In a network, the client/server model provides a convenient way to interconnect programs that are distributed efficiently across different locations. Specific to the Web, a Web server is the computer program (housed in a computer) that serves requested HTML (hypertext markup language) pages or files. A Web client is the requesting program associated with the user. The Web browser in a personal computer is a client that requests HTML files from Web servers.

According to the present invention, home server 30 has, as discussed later, an internal wireless network module for communicating with the home robot 40, an external network module connected to an external network for communication with service servers 10, and a hardware module for processing data.

The hardware module is a hardware part of the home server 30 except for the internal/external network modules. It includes a control unit, a memory, a hard disk, a plurality of data/control buses and a power unit.

An operating system (OS) is selected from various real-time operating systems (RTOS), and can be embedded in the hardware module.

Software for operating the operating system (OS) and providing services, namely a software module for embodying the operating system (OS), service frameworks and various robot function services, is formed on the hardware module.

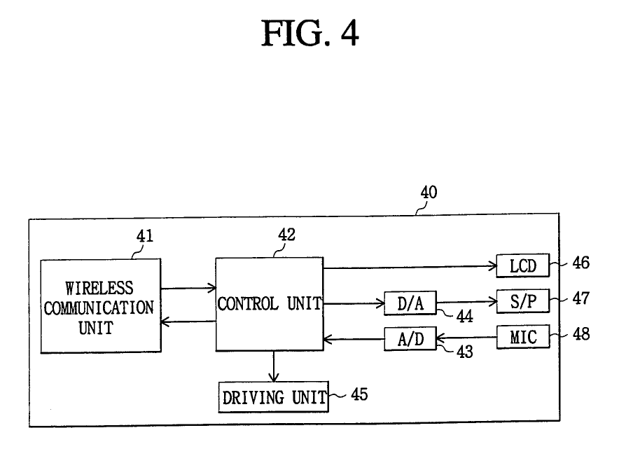

The home robot 40 can be composed of basic modules such as a CPU, a microphone, an LCD, a speaker and a network module. That is, the home robot 40 does not have to include sub-processors by functions and modules like the general autonomous robot. It is thus possible to reduce unit cost and battery consumption by forming the home robot 40 with a minimum number of basic modules. The home robot 40 will be further discussed in connection with FIG. 4.

The service servers 10 provide downloadable service software, i.e., software modules, for download to home server 30.

FIG. 3 is a detailed block diagram illustrating the home server in accordance with the preferred embodiment of the present invention.

Referring to FIG. 3, the home server 30 includes an external communication unit 31, a voice recognizing unit 32, a voice synthesizing unit 33, a control unit 34, an internal communication unit 35, a home robot driving managing unit 36 and a history managing unit 37.

The external communication unit 31 is a communication interface accessing the corresponding external service server 10 through the network 20 when information of the service server 10 is required for operations for interpreting a signal from the home robot 40 and generating a response signal. The external communication unit 31 can interface equipment for communicating over a communication path which may include at least one of a digital subscriber line (DSL), a cable modem and a private line, according to a network accessing type.

The internal communication unit 35 receives a wireless signal from the home robot 40, and transmits a response signal to the home robot 40. Thus, the internal communication unit 35 selects one or more of local area wireless communication types.

For further understanding of the invention described below, a wireless LAN (WLAN) is one in which a user can connect to a local area network (LAN) through a wireless (radio) connection. A standard, IEEE 802.11, specifies the technologies for wireless LANs. The IEEE standard includes an encryption method, the Wired Equivalent Privacy algorithm, which may or may not be used in the present invention.

For example, the internal communication unit 35 can select IEEE 802.11a, IEEE 802.11b, Bluetooth or infrared ray communication for communing with the home robot 40, and select an HPNA (Home Phone Line Network Alliance (a.k.a., Home Phoneline Networking Association)) module and a PLC (power line conversion) module for communicating with a PC (personal computer) and electric home appliances.

Each of the internal and external communication units 35 and 31 includes a selected network interface device and a communication module control unit for controlling the selected device.

When receiving a voice signal from the home robot 40, the voice recognizing unit 32 recognizes the voice so that the control unit 34 can interpret the voice signal to interpret a command of the user.

When the control unit 34 intends to transmit a response signal to the home robot 40, the voice synthesizing unit 33 synthesizes the voice to generate a voice response signal.

That is, when receiving wireless signals from the home robot 40 through the internal communication unit 35, the control unit 34 transmits voice signal data (of the wireless signals) to the voice recognizing unit 32 and status information data (of the wireless signals) of the home robot 40 to the home robot driving managing unit 36 and history managing unit 37. In addition, the control unit 34 receives a voice recognition result from the voice recognizing unit 32, interprets the command of the user, and performs operations for the interpreted command.

The home robot driving managing unit 36 obtains status information of the home robot 40 received through the internal communication unit 35 in the form of the wireless signal, and confirms the current status (e.g., current location) of the home robot 40. When the home robot 40 needs to be driven according to the operation results of the control unit 34, the home robot driving managing unit 36 generates corresponding driving control signals for moving various movable components of the home robot 40, and transmits the driving control signals to the home robot 40 through the control unit 34 and the internal communication unit 35. The home robot 40 moves according to the driving control signals generated by the home robot driving managing unit 36.

The history managing unit 37 manages a general history of the home robot 40 such as registration information, operation information, accident information and residential position for various operations of the control unit 34. The registration information includes an ID (identification) of the home robot 40, a product number and product specifications of the home robot 40, and personal information of an owner (name, address, phone number and resident registration number). The personal information can be added or updated from the servers 10 through the network 20, for efficiently managing the home robot 40.

It is expected that the home server 30 for supporting the home network such as home PNA, PLC or IEEE1394 (High Performance Serial Bus, an electronics standard for connecting devices to a personal computer) will be generally installed in each home premises. As a result, the aforementioned software module can be installed without causing additional hardware expenses or by minimizing them.

Although not illustrated, the home server 30 can further include an image processing unit for processing an image and generating an image response message so that the response message generated in the control unit 34 can be reproduced as an image on a liquid crystal display (LCD) of the home robot 40.

FIG. 4 is a block diagram illustrating the home robot in accordance with the preferred embodiment of the present invention.

As depicted in FIG. 4, the home robot includes a wireless communication unit 41, a control unit 42, an analog-to-digital (A/D) converter 43, a digital-to-analog (D/A) converter 44, a driving unit 45, an LCD 46, a speaker 47 and a microphone 48.

The wireless communication unit 41 converts the digital signal generated by A/D converter 43 and control unit 42 into a wireless (WLAN) signal, and transmits the wireless signal to the home server 30. In addition, the wireless communication unit 41 receives the wireless signal from the home server 30, converts it to a digital signal and transmits the digital signal to the control unit 42.

When receiving a voice command from the user via the microphone 48, the A/D converter 43 digitally converts the voice signal to transmit it to the control unit 42 which in turn transmits the voice command to the home server 30 through the wireless communication unit 41.

When the home server 30 interprets the command and makes a response to the command, the control unit 42 receives a response result through the wireless communication unit 41. The control unit 42 then transmits the response result to either the D/A converter 44 for conversion to an analog voice signal for audio output by speaker 47, or generates a driving control signal for moving one or more components of the home robot 40 and transmits the driving control signal to driving unit 45, and/or converts it to an image signal for display by LCD 46.

A memory of the control unit 42 requires minimum memory specifications to serve as a kind of cache. Therefore, a large capacity memory for processing a lot of signals is not necessary.

The A/D converter 43 and the D/A converter 44 are distinguished from the related arts in that they perform minimum functions for digital communication.

The microphone 48 receives the voice of the user, converts it into an electric signal, and transmits the electric signal to the A/D converter 43.

As described above, the home robot 40 of the invention is composed of a minimum number of modules.

The home robot 40 can be easily constituted by those skilled in the art which the present invention pertains to. If necessary, it can further include an image sensor such as a sensor camera or other sensors, such as sonic sensors, infrared sensors, etc.

The home robot 40 of the invention serves as a mobile interface device or a remote controller.

The process for processing the voice command of the user in the home robot will now be explained.

The home server 30 and the home robot 40 communicate with each other through the network module. For this, the home robot 40 includes the wireless communication unit 41. Preferably, a digital wireless communication module is used as the network module. Various types of network modules can be used, but a high data rate network module is preferably used. For example, in the case of 802.11b WLAN, a data rate of 10 Mbps is obtained, and in the case of 802.11a WLAN, a data rate of 50 Mbps is obtained. In the preferred embodiment of the present invention, the communication module having a data rate of at least 10 Mbps is recommended.

The uses of the home robot 40 are generally restricted to a user's premises. Therefore, a data rate is rarely restricted by a communication distance between the home server 30 and the home robot 40.

When the home server 30 receives the command from the home robot 40, the home server 30 analyzes the command through the voice recognizing unit 32, and transmits an analysis, or command result, to the control unit 34. The control unit 34 performs operations corresponding to the command result, and then performs functions for executing the command.

For example, in order to move the home robot 40 as a result of the analysis, the control unit 34 transmits the command result to the home robot driving managing unit 36, which in turn generates the driving control signal for moving the home robot 40. Control unit 34 receives the driving control signal from home robot driving managing unit 36, and transmits the driving control signal to the control unit 42 of the home robot 40 via internal communication unit 35 and wireless communication unit 41. Control unit 42 then transmits the driving control signal to driving unit 45.

Although not illustrated, the home server 30 downloads software modules, for services to be performed by the home robot 40, from the external service servers 10, and positions them in the service frameworks of the hardware module.

That is, the home server 30 accesses the plurality of service servers 10 through the external communication unit 31, and downloads various services modules provided by each service server 10. Accordingly, in the home server 30, service modules for accessing the service servers 10 and requesting and receiving necessary information can be embodied in the form of software. Such software modules include an electric home appliance control module or internet information search module

Accordingly, when a user desires for the home robot 40 to turn a television on by voice command, the electric home appliance control module of the software modules in the home server 30 is operated to generate a TV ON command, which is then transmitted to the home robot 40 to execute the command.

In addition, in the case of an Internet information search function, when the command is a next day weather forecasting command, the Internet information search module is operated to obtain a result. The result can be sent as a voice signal or as an image signal.

When transmitting the result as a voice signal, the voice synthesizing module 33 is utilized to convert the weather information to digital voice information for transmission to the home robot 40. The home robot 40 digital-to-analog converts the voice information in the D/A converter 44, and notifies the user through the speaker 47.

On the other hand, if the result is to be sent as an image signal, the home server 30 can directly transmit the Internet search information to the home robot 40, and the home robot 40 can notify it to the user through the screen of the LCD 46.

In accordance with another aspect of the invention, a messenger function can be performed. That is, the user gives a command, for transmitting a message to another person, to the home robot 40. In this case, the home robot 40 may require a camera and a distance discriminating sensor.

In addition, the home server 30 can include a map building module and a robot path control module. The map building function enables the home robot 40 and home server 30 to obtain image information and create a map of the home robot's environment. A number of related prior patents have been secured for registration, and thus it can be easily embodied by those skilled in the art. The path control function forms an optimal robot path from one point to another by using information from the distance discriminating sensor.

When a user in one room gives a command to the home robot 40 for transmitting a message to a user (intended recipient) in another room, the home robot 40 appears to understand and perform the command of the user, however, the home server 30 actually understands the command of the user, but the home robot 40 acts as if it understood the command.

Since the home robot 40 needs to move from one location to another, the current position of the home robot 40 is continuously monitored by the home server 30, and the home server 30 controls the home robot 40 to move to the room which another user stays in according to the position information of the home robot 40, the map building function and the path control function.

The home robot 40 moves according to the command of the home server 30 without making any decision. When the home robot 40 reaches another room, the home server 30 transmits the message which it has received from the user, and stored in its local memory, to the home robot 40, and the home robot 40 provides the message to the intended recipient.

A face recognizing module can be used to confirm whether the intended recipient is absent. If the home robot 40 meets the intended recipient, it delivers the message.

In addition, the home robot 40 can be used to cover a shadow area of the home wireless network. That is, a software module for performing a repeater function is mounted on the home robot 40, and thus the home robot 40 serves as a mobile repeater in the electric wave shadow area by using its mobility. Here, repeater modules have been publicly known, and thus detailed explanations thereof are omitted.

The home robot 40 can be used for a home monitoring service. That is, a database is built in the home server 30 by transmitting information on humans, electric home appliances and crime prevention to the home server 30 in order to analyze and handle specific cases. Here, the building of such a database has been publicly known and used in various fields, and thus detailed explanations thereof are omitted.

Moreover, the home robot 40 can be employed in an education field. That is, when receiving a voice question from the user, the home robot 40 digitally converts the voice question in the A/D converter 43, and transmits it to the home server 30 through the wireless communication unit 41 via control unit 42. The home server 30 searches for an answer to the voice question, and transmits a found answer to the home robot 40. The home robot 40 receives the answer as a digital voice signal through the wireless communication unit 41, converts the voice signal to an analog voice signal in the D/A converter 44, and reproduces the converted signal through the speaker 47, thereby performing a question and answer function.

The home robot 40 can perform a home interphone function. That is, when an external user transmits image and voice signals through the network 20 to home server 30, the home robot 40 receives the image signal and reproduces it through the LCD 46, and receives the voice signal, D/A converts the voice signal in the D/A converter 44, and reproduces the converted signal as voice through the speaker 47, to perform an image interphone function.

In accordance with the present invention, due to the software service performed by the home server, large capacity processing operations which have not been successfully performed by prior high-priced robots can be successfully performed by a low-priced robot, and the user can be continuously provided with high-quality services because the hardware of the robot needs not be replaced during upgrading services.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system for controlling a home robot, comprising:
a home server responsive to a user's command for controlling said home robot, said home server and said home robot being in a same premises; and
said home robot being controlled to perform only in response to command result signals generated by said home server, said command result signals being generated in response to said user's command.

2. The system as set forth in claim 1, said user's command being transmitted as a wireless local area network (WLAN) signal to said home server via said home robot for analysis by said home server.

3. The system as set forth in claim 1, said home server comprising:
an internal communication unit generating and receiving wireless local area network (WLAN) signals for communicating with said home robot;
a control unit for analyzing the user's commands, where said wireless local area network (WLAN) signals comprises said user's command;
a voice recognition unit for performing a voice recognition function on voice signals constituting said user's commands and providing command information to said control unit, based on recognition of said voice signals, to said control unit for analyzing the user's commands in response to the command information;
a voice synthesizing unit for producing a digital voice signal when said control unit determines that said command information requires a voice response; and
a home robot driving managing unit for producing motion control signals to be transmitted to said home robot to control movements of said home robot, said digital voice signal and said motion control signals being transmitted to said home robot via said control unit and said internal communication unit as said command result signals.

4. The system as set forth in claim 1, said home robot comprising:
a microphone for receiving the user's command as an external voice command signal from the user and converting the voice command signal into an electric command signal;
an analog-to-digital converter for converting the electric command signal to a digital command signal;
a wireless communication unit for converting the digital command signal into a wireless command signal and transmitting the wireless command signal to said home server, and for receiving a wireless command result signal from the home server, said wireless communication unit converting the wireless command result signal into a digital command result signal;
a digital-to-analog converter for converting a digital voice signal to an analog voice signal when said digital voice signal is included with said digital command result signal;
a speaker for producing an audio voice signal in response to the analog voice signal from said digital-to-analog converter;
a control unit receiving said digital command result signal from the wireless command unit and analyzing said digital command result signal to control one or more actions of said home robot, and based on said analysis, said control unit outputting one or more of said digital voice signal, motion control signals and an image signal;
a driving unit for moving body components of said home robot in response to one or more of said motion control signals from the control unit, each motion control signal being determined by the analysis performed by said control unit on said digital command result signal; and
a display unit for displaying an image in response to said image signal.

5. The system as set forth in claim 4, said display unit reproducing operation status display information of the home robot.

6. The system as set forth in claim 1, further comprising a network for communicating with one or more service servers, said service servers having software modules for downloading to said home server, each service server being utilized to generate a corresponding command for controlling said home robot.

7. A method for operating a home robot using a home server, the method comprising the steps of:
receiving a voice service request analog-to-digital at the home robot, for converting the voice, and transmitting the voice to the home server through wireless communication;
receiving the voice at the home server from the home robot, for interpreting a requested service by voice recognition, performing operations for the requested service, generating a response message to the requested service, synthesizing the response message into voice, and transmitting the voice response message to the home robot; and
receiving the voice response message at the home robot from the home server, for reproducing the voice response message as voice through a speaker.
